(19) United States
(12) Patent Application Publication
(10) Pub. No.: US 2014/0052978 A1
(43) Pub. Date: Feb. 20, 2014

(54) COMPUTER SYSTEM AND ASSOCIATED STORAGE DEVICE MANAGEMENT METHOD

(71) Applicant: WISTRON CORPORATION, New Taipei City (TW)

(72) Inventor: Fang-Yuan Sung, New Taipei City (TW)

(73) Assignee: Wistron Corporation, New Taipei City (TW)

(21) Appl. No.: 13/860,599

(22) Filed: Apr. 11, 2013

(30) Foreign Application Priority Data
Aug. 14, 2012 (TW) 101129362

(51) Int. Cl. G06F 3/06

(52) U.S. Cl. CPC G06F 3/0634; G06F 3/0679; G06F 3/0604
USPC 713/100

(57) ABSTRACT

A storage device management method is provided. The method includes steps of: reading a mode selection parameter when a computer system is activated; the computer operating in a first operation mode or a second operation mode according to the mode selection parameter; determining whether the mode selection parameter is modified; and selectively changing an operation mode of the computer when the mode selection parameter is modified.

This application claims the benefit of Taiwan application Serial No. 101129362, filed Aug. 14, 2012, the subject matter of which is incorporated herein by reference.

### BACKGROUND OF THE INVENTION

1. Field of the Invention

The invention relates in general to a computer system and associated storage device management method, and more particularly to a computer system having a main storage device and an auxiliary storage device and an associated storage device method.

2. Description of the Related Art

A conventional hard disk drive (hereinafter, HDD) is formed by a disk full of magnetic materials. The invention of the HDD can be dated several decades ago. With time passed by, fundamental structures and various techniques of the HDD have been developed dramatically, hence a unit cost of the conventional HDD is constantly lowered. Nowadays, high-definition images and devices are popular, and the HDD with low cost and high storage capacity characteristics stays as the mainstream of the market.

A solid state drive (hereinafter, SSD) is mainly formed by a controller and a flash memory. A read/write speed of an SSD is significantly faster than that of the conventional HDD, but the SSD is more expensive. With its high cost, usage of the SSD is however less common.

A computer system with both of the above hard disks is available in the market. Such computer system uses the HDD as a major storage drive, and uses the SSD to raise access speed. More specifically, the SSD serves as a cache of the HDD, and stores frequently accessed data. By doing so, data access of the computer system becomes more efficient.

However, the approach of an SSD serving as a cache of a hard disk has several drawbacks. For instance, power consumption of the computer system with both SSD and HDD is much higher than that of the computer system with only an HDD.

The additional power consumption issue becomes more critical when an external power source is not provided. Two different modes using a battery device as an internal power source are compared below. According to experimental values, power consumption of a computer system with only the HDD is merely 6 W to 7 W. On the other hand, power consumption of a computer system with both HDD and SSD increases by approximately 0.5 W. That is, the power consumption of the latter is increased by about 10%. For the same reason, battery performance of the computer system with both HDD and SSD is degraded, and an operating period of the battery device is decreased for more than 5%.

For a portable device, endurance of a battery device is closely associated with its conveniences. Therefore, it is an issue yet to be solved as how to extend durability of a battery device while using an SSD to enhance system performance.

### SUMMARY OF THE INVENTION

According to an aspect of the present invention, a storage device management method for a computer system is provided. The method includes steps of: reading a mode selection parameter when the computer system is activated; the computer system operating in a first operation mode or a second operation mode according to the mode selection parameter; determining whether the mode selection parameter is modified; and selectively changing an operation mode of the computer system when the mode selection parameter is modified.

According to another aspect of the present invention, a computer system is provided. The computer system includes: a mode selection device, for reading a mode selection parameter when the computer system is activated, wherein the mode selection parameter is indicative of whether the computer system operates in a first operation mode or a second operation mode; a main storage device, electrically connected to the mode selection device, for providing a data storage function; an auxiliary storage device, electrically connected to the mode selection device, for providing a cache function; and an enable control unit, electrically connected to the mode selection device, the main storage device and the auxiliary storage device, for controlling the main storage device and the auxiliary storage device according to an operation mode of the computer system.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1A is a schematic diagram of defining a first operation mode of a computer system according to a preferred embodiment of the present invention;

FIG. 1B is a schematic diagram of defining a second operation mode of a computer system according to a preferred embodiment of the present invention;

FIG. 2A is a schematic diagram of enabled and disabled statuses of a main storage device and an auxiliary storage device in FIGS. 1A and 1B under two operation modes;

FIG. 2B is a schematic diagram of a control method for switching an operation mode according to different enabled and disabled statuses of the main storage device and the auxiliary storage device in the first operation mode and the second operation mode;

FIG. 3 is a flowchart of switching an operation mode of a computer system in different operation modes according to a preferred embodiment of the present invention;

FIG. 4A is a block diagram of a computer system according to a preferred embodiment of the present invention;

FIG. 4B is a flowchart of a computer system changing an operation mode according to a mode selection parameter according to a preferred embodiment of the present invention; and,

FIGS. 5A and 5B are flowcharts of dynamically changing an operation mode of a computer system according to a preferred embodiment of the present invention.

### DETAILED DESCRIPTION OF THE INVENTION

For a computer system, the operation duration is very limited if the computer system is powered by a battery device. Under such circumstance, the computer system with both a flash memory storage device (e.g. an SSD) and an HDD is unsustainable to long-term use when the SSD is utilized as a cache.

According to a preferred embodiment of the present invention, an approach for changing an operation mode of a computer system with both an HDD storage device and an SSD is provided. The operation mode changing of the computer system is determined by an enable control unit. Both the HDD storage device and the flash storage device can be enabled or disabled under the control of the enable control unit.

With low unit cost, the HDD storage device serves as a main storage device and provides a data storage function in the computer system. With fast access speed, the flash memory storage device serves as an auxiliary storage device in the computer system.

As previously stated, the computer system may enable or disable the main storage device and the auxiliary device via the enable control unit. In the embodiments, the computer system is defined with a first operation mode M1 in which both storage devices are enabled, and a second operation mode M2 in which only the main storage device is enabled.

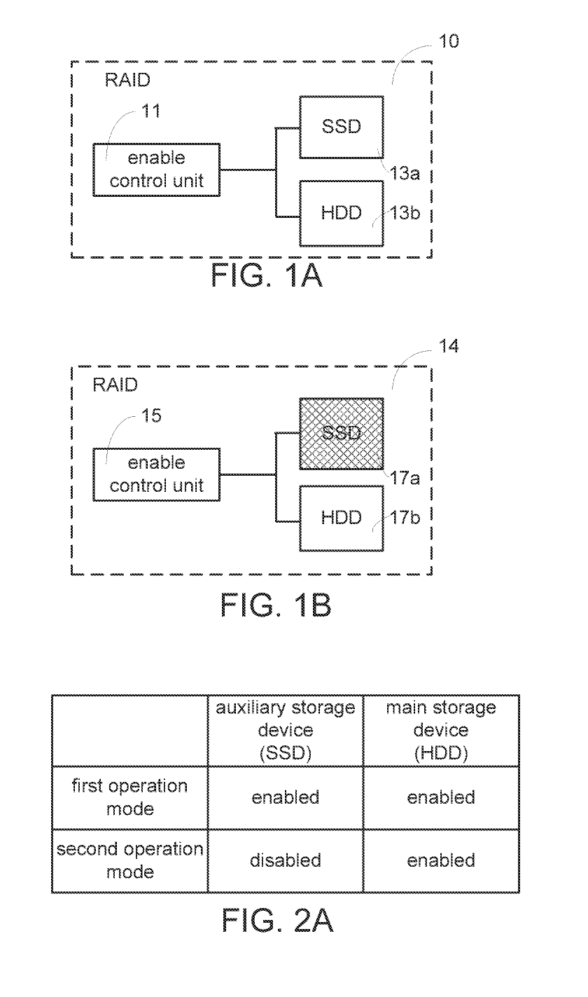

With reference of FIGS. 1A and 1B, detail descriptions of the operation modes defined in the present invention are given below. In FIGS. 1A and 1B, a redundant array of independent disks (hereinafter, RAID) 10 includes an enable control unit 11, an SSD 13a and an HDD 13b.

FIG. 1A shows a schematic diagram of the first operation mode defined for the computer system according to a preferred embodiment of the present invention.

According to a preferred embodiment of the present invention, the enable control unit changes enabled and disabled statuses of the main storage device and the auxiliary storage device according to changes of a mode selection parameter. Correspondingly, an operation mode of the computer system is also changed.

In the first operation mode M1, the enable control unit 11 enables both the SSD 13a and the HDD 13b, and the SSD 13a serves as a cache of the computer system. When a central processing unit (hereinafter CPU, not shown) accesses data in the RAID 10, the CPU directly access data from the SSD 13a, rather than the HDD 13b. Since the SSD 13a has a faster access speed, an overall access speed of the RAID 10 is enhanced.

Details of selecting cache data stored in the SSD 13a can be implemented to a person having ordinary skill in the related art by applying various types of cache-detection algorithms, and shall be omitted herein.

FIG. 1B shows a schematic diagram of the second operation mode defined for the computer system according to a preferred embodiment of the present invention. In the second operation mode M2, an enable control unit 15 disables the SSD 17a. At this point, the SSD 17a represented by a shaded block cannot be utilized. That is to say, in the second operation mode M2, the SSD 17a does not provide a cache function. The enable control unit 15 only enables an HDD 17b, and only the HDD 17b in a RAID 14 provides a data storage function.

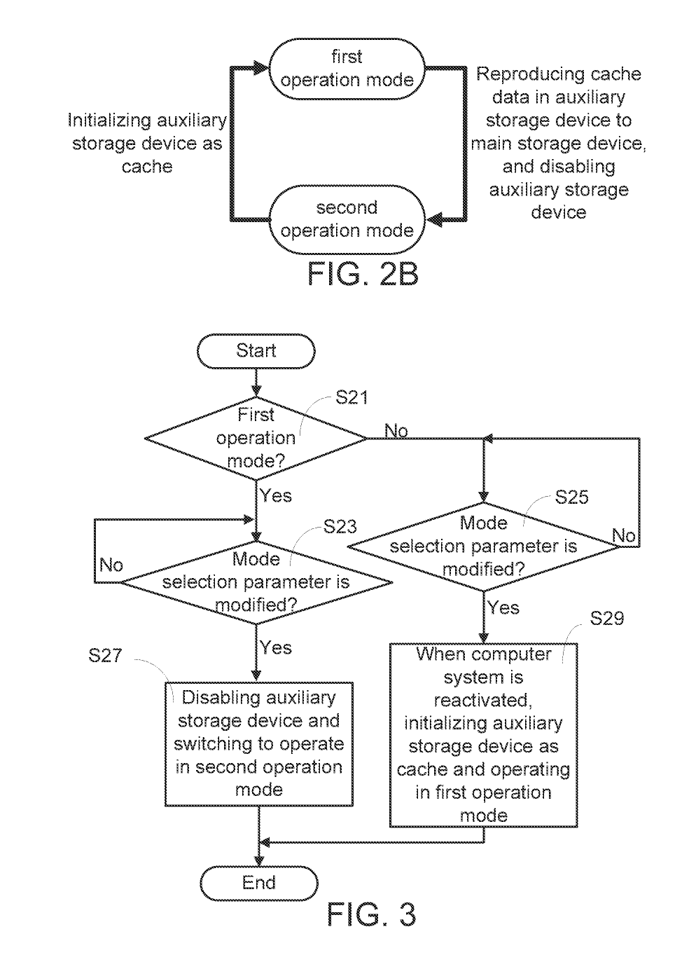

FIG. 2A shows enabled and disabled statuses of the main storage device and the auxiliary storage device in FIGS. 1A and 1B under the two operation modes. That is, FIG. 2A shows the first operation mode M1 in which the SSD and the HDD are simultaneously enabled, and the second operation mode M2 in which only the HDD is enabled.

In the first operation mode M1, since the SSD serves as a cache, a speed of the CPU accessing the RAID can be accelerated. Hence, the first operation mode M1 offers high performance.

In the second operation mode M2, the second operation mode M2 is more power-saving as only the HDD is utilized.

In other words, when the computer system operates in the first operation mode M1, the main storage device and the auxiliary storage device of the computer system are both enabled by the enable control unit. When the computer system operates in the second operation mode M2, the main storage device is enabled by the enable control unit, and the auxiliary storage device is disabled by the enable control unit.

Assuming that when a power source of the computer system is on, a basic input/output system (hereinafter, BIOS) of the computer system first initializes the SSD and HDD in the RAID at the same time. That is to say, the computer system is configured in default to operate in the first operation mode M1 when activated. When the mode selection parameter is modified, the enable control unit changes the auxiliary storage device from an enabled status to the disabled status. The operation mode of the computer system correspondingly switches from the first operation mode M1 to the second operation mode M2.

According to a preferred embodiment of the present invention, the mode selection parameter may be modified by a hardware approach or a software approach.

More specifically, a hardware approach is corresponding to whether a power supply of the computer system is changed. For instance, the mode selection parameter automatically changes its value or setting when the power supply of the computer system is changed from an external power source to an internal power source, or from an internal source to an external power source.

A software approach is corresponding to an operation interface provided by the computer system. The operation interface is implemented via an application interface, and allows a user to selectively and manually change a value or setting of the mode selection parameter.

In practice, the mode selection parameter may be modified by either a software-only modified approach or a hardware-only modified approach. Further, the mode selection parameter may also be set to be modified by software cooperating with hardware.

FIG. 2B shows a schematic diagram of a computer system changing from the first operation mode to the second operation mode according to a preferred embodiment of the present invention.

As previously described, when the computer system is in the first operation mode M1, the SSD serves as a cache; and, when the computer system is in operation mode M2, the SSD is disabled.

Thus, to change the computer system from the original first operation mode M1 to the second operation mode M2, it implies that the SSD needs to be changed from an enabled status to the disabled status.

Therefore, the computer system first reproduces one copy of cache data in the SSD to the HDD. The SSD is then controlled to be disabled after the cache data is copied and reproduced to the HDD. Meanwhile, the operation mode is switched to the second operation mode M2.

FIG. 2B further shows details of a control method for changing an operation mode according to different enabled and disabled statuses of the main storage device and the auxiliary storage device in FIG. 2A in the first operation mode and the second operation mode.

When the computer system operates in the first operation mode M1, the SSD and the HDD are both enabled. When the computer system operates in the second operation mode M2, the SSD is disabled.

Thus, to switch the computer system from the first operation mode M1 to the second operation mode M2, it implies that the SSD needs to be disabled from the original enabled status. At this point, the computer system first reproduces the cache data in the SSD to the HDD to prevent the updated cache data in the SSD from being lost. The computer system then disables the HDD and switches to operate in the second operation mode M2.

In contrast, to switch the computer system from the second operation mode M2 to the first operation mode M1, it implies that the SSD needs to be enabled from the original disabled status.

To switch the computer system from the second operation mode M2 to the first operation mode M1, the SSD is first initialized in order to be served as a cache. The initialization process is generally performed by the BIOS. Thus, if the SSD does not undergo the initialization process for a cache, the computer system will operate in the first operation mode M1 after a next power-on.

Thus, as described with reference to FIGS. 2A and 2B, the control process for changing the statuses of the main storage device and the auxiliary storage device when the operation mode of the computer system is to be switched. Details of changing the operation mode in response to a modified mode selection parameter according to different operation modes are further described below.

According to a preferred embodiment of the present invention, the mode selection parameter is indicative of the operation mode of the computer system. When the mode selection represents the first operation mode M1, the computer system operates in the first operation mode M1. When the power utilization status represents the second operation mode M2, the computer system operates in the second operation mode M2.

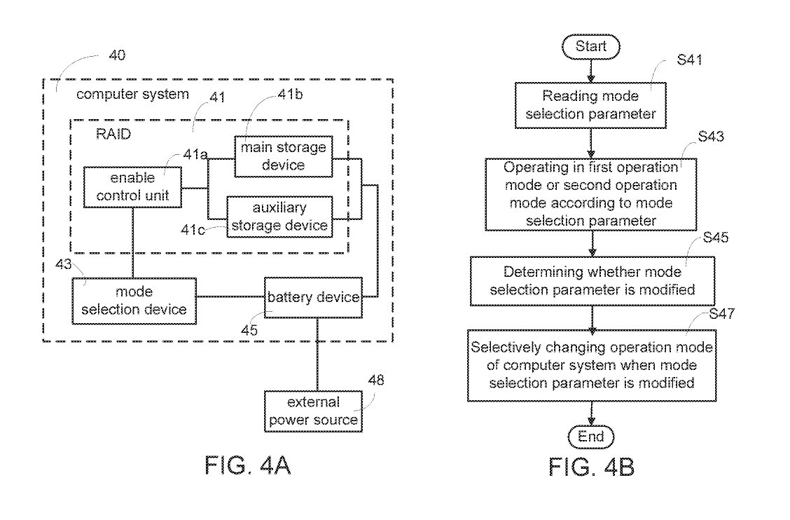

FIG. 3 shows a flowchart of changing an operation mode of a computer system in different operation modes according to a preferred embodiment of the present invention.

In step S21, it is determined whether the computer system operates in the first operation mode M1.

When a determination result of step S21 is affirmative, it means the computer system operates in the first operation mode M1. In step S23, it is determined whether the mode selection parameter is modified.

When a determination result of step S23 is negative, step S23 is repeated to again to determine whether the mode selection parameter is modified. When the determination result of step S23 is affirmative, it means that the first operation mode M1 is to be changed to the second operation mode M2. Thus, in step S27, the computer disables the auxiliary storage device after reproducing the cache data, and switches to operate in the second operation mode M2.

When the determination result of step S21 is negative, it means that the computer system operates in the second operation mode M2. In step S25, it is determined whether the mode selection parameter is modified.

When a determination result of step S25 is negative, step S25 is repeated to again to determine whether the mode selection parameter is modified. When the determination result of step S25 is affirmative, it means that the second operation mode M2 is to be changed to the first operation mode M1. In step S29, after the computer system is restarted, the auxiliary storage is initialized as a cache, and then the computer system changes to operate in the first operation mode M1.

It should be noted that, the mode selection parameter in step S23 and in step S25 may be modified based on two reasons—the mode selection parameter is modified via an operation interface provided by a application software, or is modified according to a power utilization status of the computer system. The power utilization status indicates the computer system is powered by an external power source or an internal power source.

The method of modifying the mode selection parameter via the operation interface provided by a application software allows a user to perform personalized configurations according to personal preferences or operation habits.

Further, in response to different considerations of the computer system being powered by an external power source or a battery device, the mode selection parameter may change according to a power utilization status. When the computer system is powered by an external power source, the computer system is preferably operated in the first operation mode M1. When the computer system is powered by a battery device, the computer system is preferably operated in the second operation mode M2.

Thus, when the power source status changes, e.g., when the power source switches from an external power source to a battery device, or switches from a battery device to an external power source, the mode selection parameter may be correspondingly modified.

When the computer system is activated, the computer system selectively operates in the first operation mode M1 or the second operation mode M2 according to the mode selection parameter. Further, the operation mode of the computer system is determined according to changes of the mode selection parameter. In a preferred embodiment, the computer system may provide an application software. Via the application software, a value or setting of the mode selection parameter may be modified.

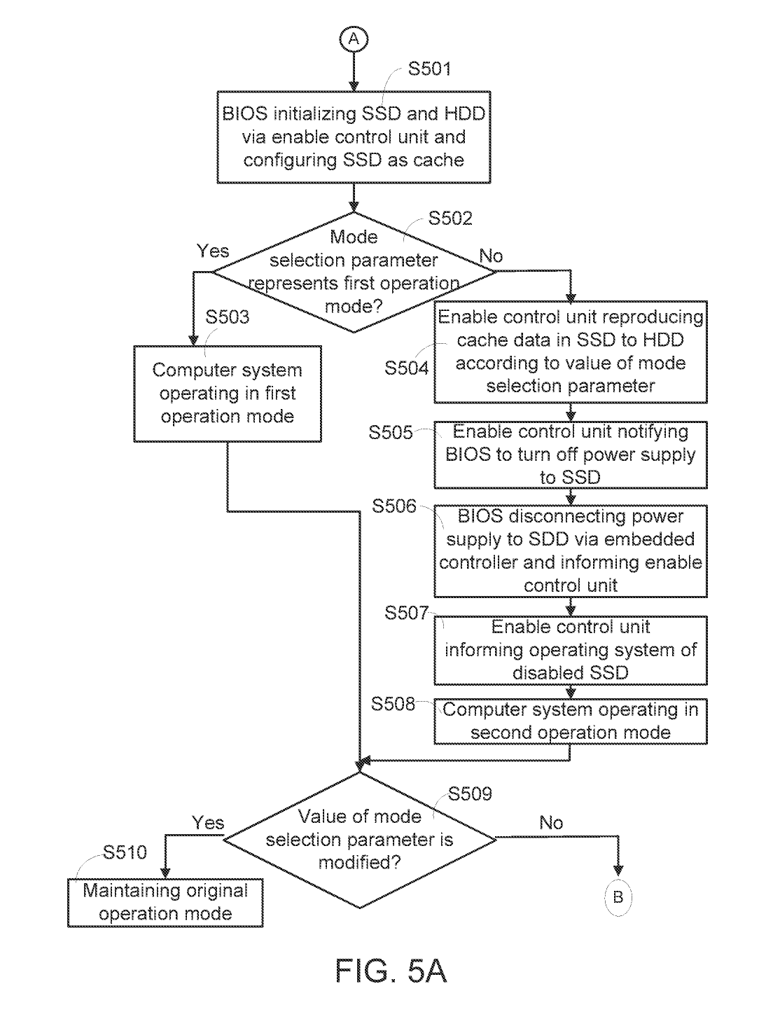

FIG. 4A shows a block diagram of a computer system according to a preferred embodiment of the present invention.

Referring to FIG. 4A, a computer system 40 includes a mode selection device 43, a RAID 41 and a battery device 45. The RAID 41 includes a main storage device 41b, an auxiliary battery device 41c and an enable control unit 41a. The computer system 40 may be electrically connected to an external power source 48.

The mode selection device 43 is electrically connected to the enable control unit 41a. It should be noted that although the mode selection device 43 is depicted in a block, functions of the mode selection device 43 may be jointly provided by an embedded controller, BIOS, a CPU and a chipset in practice.

When the computer system 40 is activated, the mode selection device 43 reads a mode selection parameter. The mode selection parameter indicates whether the computer system 40 operates in a first operation mode M1 or a second operation mode M2.

The main storage device 41b provides a data storage function, and the auxiliary storage device 41c provides a cache function. The enable control unit 41a is electrically connected to the mode selection device 43, the main storage unit 41b and the auxiliary storage unit 41c. According to the mode selection parameter, the enable control unit 41a cooperates with the mode selection device 43. Based on the control of the enable control unit 41a, operation mode of the computer system 40 changes, and the main storage device 41b and the auxiliary storage device 41c are correspondingly enabled/disabled.

When the computer system 40 operates in the first operation mode M1, the main storage device 41b and the auxiliary storage device 41c are both enabled by the enable control unit 41a. When the computer system 40 operates in the second operation mode M2, the main storage device 41b is enabled, and the auxiliary storage device 41c is disabled by the enable control unit 41a.

The mode selection device 43 provides an operation interface for modifying the mode selection parameter, and determines whether the mode selection parameter is modified. For example, the mode selection device 43 provides application software with an operation interface. Or, the mode selection device 43 cooperates with original battery device management software that additionally provides a configuration option of the mode selection parameter.

When the mode selection parameter is modified, the computer system 40 selectively changes the operation mode.

When the mode selection parameter is modified while the computer system 40 operates in the first operation mode M1, the computer system 40 needs to switch from the first operation mode M1 to the second operation mode M2. At this point, the mode selection device 43 reproduces contents of the auxiliary storage device 41c to the main storage device 41b and stores the modified mode selection parameter. In addition, the enable control unit 41a consequently disables the auxiliary storage device 41c.

On the other hand, when the mode selection parameter is modified while the computer system 40 operates in the second operation mode M2, the computer system 40 needs to initialize the auxiliary storage device 41c before switching its operation mode. At this point, the mode selection device 43 stores the modified mode selection parameter and maintains operations in the second operation mode M2. When the computer system 40 is activated in a next power-on, the mode selection device 43 determines that the computer system 40 is expected to operate in the first operation mode M1 according to the stored mode selection parameter. The computer system 40 thus initializes the main storage device 41b and disables the auxiliary storage device 41c after activation.

FIG. 4B shows a flowchart of a computer system changing an operation mode according to the mode selection parameter according to a preferred embodiment of the present invention. Referring to FIG. 4B, the storage device management method includes the following steps.

In step S41, a mode selection parameter is read when the computer system is activated. In step S43, the computer system operates in a first operation mode M1 or a second operation mode M2 according to the mode selection parameter. In step S45, it is determined whether the mode selection parameter is modified. In step S47, an operation mode of the computer system is selectively changed when the mode selection parameter is modified.

Step S47 may be classified as two situations. In the first situation, when the computer system operates in the first operation mode M1, the computer system switches from the first operation mode M1 to operate in the second operation mode M2 according to the modified mode selection parameter. In the second situation, when the computer system operates in the second operation mode M2, the computer system stores the modified mode selection parameter, and keeps operating in the second operation mode M2.

According to a first preferred embodiment of the present invention, a value or setting of the mode selection parameter may be modified via an operation interface provided by an application software.

When the mode selection parameter originally represents the first operation mode M1, details of modifying the value of the mode selection parameter via an operation interface are described below.

A user first activates the application software, and manually modifies the value or setting of the mode selection parameter. The value or setting of the mode selection parameter is changed from the first operation mode M1 to the more power-saving second operation mode M2. When the configuration of the mode selection parameter changes, a notification signal is issued to a driver of the enable control unit. The notification signal may be generated via an application interface (hereinafter, API) of the operating system. Afterwards, the computer system reproduces cache data in the auxiliary storage device to the main storage device, and modifies the value of the mode selection parameter (from the first operation mode to the second operation mode).

The driver of the enable control unit notifies the BIOS via a Windows Management Instrumentation (hereinafter, WMI) interface of the operating system to turn off the auxiliary storage device. The BIOS then notifies the embedded controller to disconnect the power supply to the auxiliary storage device.

After turning off the auxiliary storage device, a system control interrupt (SCI) is triggered to inform the BIOS/operating system. The driver of the enable control unit then notifies the operating system via the API of the operation interface that the auxiliary storage device is safely removed. The operating system thus stops utilizing the cache function.

Through the foregoing procedure, the computer system completes the process of switching from the first operation mode M1 to the second operation mode M2. At this point, the operating system only operates under a normal operation condition with the main storage device only.

When the computer system originally utilizes a battery device as a power source, value or setting of the mode selection parameter originally corresponds to the second operation mode M2. In practice, the computer system may change from the second operation mode M2 to the first operation M1 according to two reasons. For instance, an user manually changes the value or setting of the mode selection parameter, or the user connects the computer system to the external power supply while using the computer system. Details of how the computer system enables/disables its storage drives when the computer system changes its operation mode from the second operation mode M2 to the first operation mode M1 are described below.

A user may use an operation interface provided by the application software, and manually modify the value or setting of the mode selection parameter. Via the operation interface, the user is informed that the computer system will operate in the first operation mode M1 only after the next power-on. Meanwhile, the operation interface modifies the value or setting of the mode selection parameter. The original value or setting of the mode selection parameter corresponds to the second operation mode M2, and the modified one corresponds to the first operation mode M1. Accordingly, the computer system will be activated in the first operation mode M1 when the computer system is powered on next time.

According to a second preferred embodiment of the present invention, the mode selection parameter changes the operation mode according to a power utilization status of the computer system.

When the power utilization status indicates that the computer system is powered by an external power source, the mode selection parameter represents the first operation mode M1. Since the external power source provides abundant power, amount of power consumed by the SDD and the HDD is not a concern.

When the power utilization status indicates that the computer system is powered by a battery device, the mode selection parameter represents the second operation mode M2.

When a user unplugs a transformer of the computer system from an external power source, the computer system is switched to be powered by a battery device.

Therefore, when a user removes a charger from the computer system, the computer system is to switch from the first operation mode M1 to the more power-saving second operation mode M2. Associated details are described below.

The configuration software of the mode selection parameter notifies the driver of the enable control unit via the API of the operating system. The computer system reproduces the cache data in the auxiliary storage device to the main storage device, and modifies the value or setting of the mode selection parameter (from the first operation mode M1 to the second operation mode M2).

The driver of the enable control unit notifies the BIOS via the WMI interface of the operating system to switch off the auxiliary storage device. The BIOS then notifies the embedded controller by an I/O approach to switch off the auxiliary storage device.

After switching off the auxiliary storage device, the driver of the enable control unit triggers the SCI to notify the BIOS/operating system. The driver of the enable control unit then informs the operating system via the API of the operating system that the auxiliary storage device is safely removed. Thus, the operating system stops utilizing the cache function.

With the foregoing procedure, the computer system completes the process of changing from the first operation mode M1 to the second operation mode M2. At this point, the operating system only operates under a normal operation condition with the main storage device, and does not employ the auxiliary storage device as a cache.

When the computer system is originally powered by a battery device and is later connected to an external power source by a user, associated details are described below.

When the user connects the computer system to a charger, it means the power utilization status of the computer system is switched from an internal power mode to an external power mode. Therefore, the computer system is to switch from the second operation mode M2 to the first operation mode M1. Next, via the application software, the computer system informs the user that the computer system will be activated in the first operation mode M1 when the computer system is powered on next time. Meanwhile, the value or setting corresponding to the mode selection parameter is modified from the original second operation mode M2 to the first operation mode M1. Consequently, the computer system will operate in the first operation mode M1 when the computer system is powered-on next time.

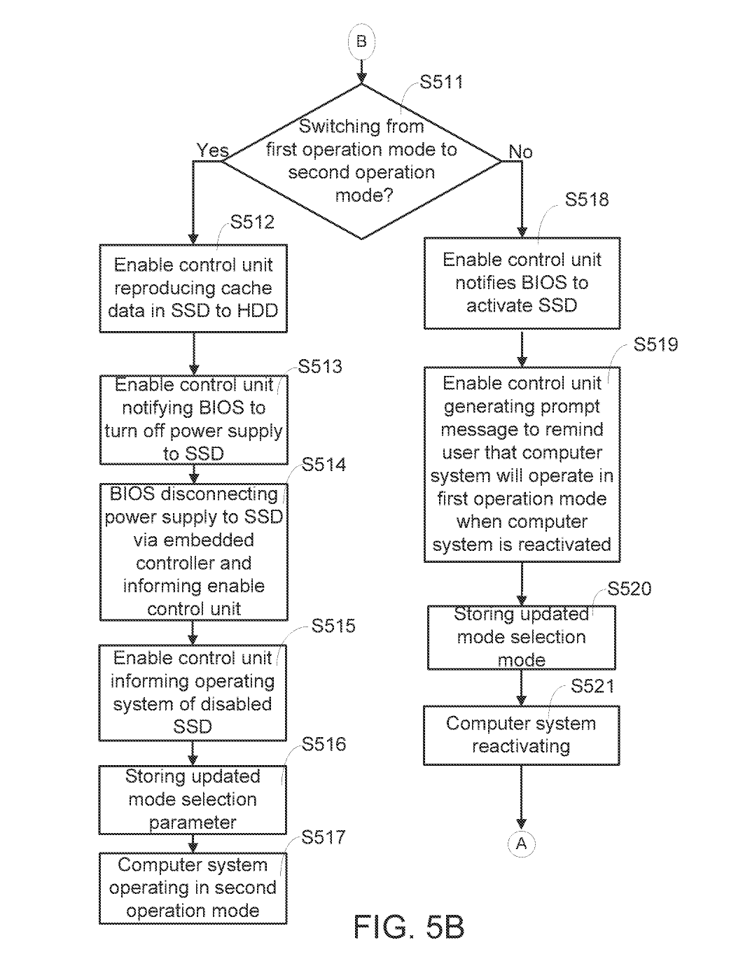

FIGS. 5A and 5B show flowcharts of dynamically changing an operation mode of a computer system according to a preferred embodiment of the present invention.

In step S501, the BIOS initializes the SSD and the HDD via the enable control unit, and configures the SSD as a cache of the HDD. In step S502, after activating the operating system, the operation interface (application software) for setting/reading the mode selection parameter confirms the current value of the mode selection parameter, and it is assumed a determination result indicates that the mode selection parameter represents the first operation mode M1. In step S503, when the determination result represents the first operation mode M1, the computer system operates in the first operation mode M1.

When the determination result of step S502 is negative, it means that the computer system is to operate in the second operation mode M2. Therefore, in step S504, the operation interface for setting/reading the mode selection parameter notifies the enable control unit. In addition, the latest cache data in the SSD are reproduced and copied to the HDD. In step S505, after reproducing the cache data, the enable control unit notifies the BIOS to turn off the SSD.

In step S506, the BIOS turns off the SSD via the embedded controller, and notifies the enable control unit afterwards. In step S507, via the operation interface for setting/reading the mode selection parameter, the enable control unit informs the operating system that the SSD is disabled. In step S508, the operating system no longer utilizes the SSD, and the computer system switches to the second operation mode M2.

As previously described, during operations of the computer system, the operation mode represented by the mode selection parameter may be changed due to several reasons. For instance, the mode selection parameter is modified as the power utilization status changes, or its value is changed by a user via the operation interface.

In step S511, according to the modified mode selection parameter, it is determined whether the operation mode of the computer system is to be switched from the first operation mode M1 to the second operation mode M2, or from the second operation mode M2 to the first operation mode M1.

The first situation of switching from the first operation M1 to the second operation mode M2 shall be discussed below. This switching process is corresponding to the left branch in FIG. 5B. In FIG. 5B, apart from step S516 for storing an updated mode selection parameter, details of other steps S512, S513, S514, S515 and S517 are respectively similar to those of steps S504, S505, S506, S507 and S508 in FIG. 5A, and shall be omitted herein.

The second situation of switching from the second operation mode M2 to the first operation mode M1 shall be discussed below. This switching process is corresponding to the right branch in FIG. 5B. In step S518, the enable control unit notifies the BIOS to restore the power supply to the SSD. In step S519, the enable control unit generates a prompt message to remind the user that the computer system will operate in the first operation mode M1 when the computer system is reactivated. In step S520, the updated mode selection parameter is stored. In step S521, the computer system is waiting for the user to reactivate.

In the foregoing preferred embodiment, two exemplary situations of the mode selection parameter and the power utilization status are described for explaining the approach for determining the operation mode of the computer system. In an alternative embodiment, the computer system may also combine considerations based on software and hardware to determine the selected operation mode.

In such case, considerations of software and hardware causing the modified mode selection parameter are regarded as determination bases for determining whether the operation mode is to be switched. Thus, details of controlling associated devices when switching between the operations modes are omitted herein.

For example, while modifying the mode selection parameter, the computer system may consider the power utilization status first.

Hence, when the computer system is powered by the external power source, the computer system determines its operation mode according to the mode selection parameter.

In contrast, when the computer system is powered by the battery device, the power utilization status indicates that the computer system should operate in a power-saving mode. Hence, the second operation mode may be set to as the default operation mode of the computer system. At this point, the operation interface is not provided. That is, the user may be prohibited from modifying the mode selection parameter when the computer system is powered by the internal power source.

In such case, when the computer system changes its power source from the external to internal, the computer system will accordingly change to the second operation mode M2. By doing so, the computer system consumes less power and provides a longer operating period.

In practice, details of combining the operation interface and the power utilization status for modifying the mode selection parameter are not limited to the above descriptions. The implementation of managing operation mode switching may be planned and adjusted according to application requirements of the computer system. Alternatively, the user may also define the determination approach from combining the mode selection parameter and the power utilization status according to personal preferences or operation habits.

It is demonstrated in the foregoing embodiments that, the storage device management method and the computer system dynamically change operation mode of the computer system. The settings corresponding to the operation mode are changed according to the power utilization status of the computer system and/or the operation interface. The computer system can swiftly switch from the high-performance first operation mode M1 to the more power-saving operation mode M2. Therefore, the computer system according to the present invention is capable of satisfying both high-performance and power-saving requirements.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A storage device management method for a computer system, comprising steps of:
reading a mode selection parameter when the computer system is activated;
the computer system operating in a first operation mode or a second operation mode according to the mode selection parameter;
determining whether the mode selection parameter is modified; and
selectively changing an operation mode of the computer system when the mode selection parameter is modified.

2. The storage device management method according to claim 1, wherein when the computer system operates in the first operation mode, a main storage device and an auxiliary storage device of the computer system are both enabled; and, when the computer system operates in the second operation mode, the main storage device is enabled and the auxiliary storage device is disabled.

3. The storage device management method according to claim 2, further comprising step of:
initializing the main storage device and the auxiliary storage device.

4. The storage device management method according to claim 2, wherein the main storage device is a hard disk drive and the auxiliary storage device is a solid state drive.

5. The storage device management method according to claim 2, wherein the main storage device provides a data storage function, and the auxiliary storage device provides a cache function.

6. The storage device management method according to claim 1, wherein when the mode selection parameter is modified, the step of selectively changing the operation mode of the computer system comprises steps of:
when the computer system operates in the first operation mode, the computer system switches to operate in the second operation mode according to the modified mode selection parameter; and
when the computer system operates in the second operation mode, the computer system stores the modified mode selection parameter, and keeps operating in the second operation mode.

7. The storage device management method according to claim 6, wherein the computer system comprises a main storage device and an auxiliary storage device, and the step of the computer system switching to operate in the second operation mode according to the modified mode selection parameter when the computer system operates in the first operation mode comprises steps of:
reproducing contents of the auxiliary storage device to the main storage device;
storing the modified mode selection parameter; and
disabling the auxiliary storage device.

8. The storage device management method according to claim 1, wherein the mode selection parameter is modified via an operation interface or is modified according to a power utilization status of the computer system.

9. The storage device management method according to claim 1, wherein the mode selection parameter represents the first operation mode when the computer system is powered by an external power source;
and, the mode selection parameter represents the second operation mode when the computer system is powered by a battery device.

10. A computer system, comprising:
a mode selection device, for reading a mode selection parameter when the computer system is activated, wherein the mode selection parameter is indicative of whether the computer system operates in a first operation mode or a second operation mode;
a main storage device, for providing a data storage function;
an auxiliary storage device, for providing a cache function; and
an enable control unit, electrically connected to the mode selection device, the main storage device and the auxiliary storage device, for controlling the main storage device and the auxiliary storage device according to an operation mode of the computer system.

11. The computer system according to claim 10, wherein when the computer system operates in the first operation mode, the main storage device and the auxiliary storage device are both enabled; and, when the computer system operates in the second operation mode, the main storage device is enabled and the auxiliary storage device is disabled.

12. The computer system according to claim 10, wherein the mode selection device provides an operation interface for modifying the mode selection parameter, and determines whether the mode selection parameter is modified.

13. The computer system according to claim 12, wherein the computer system selectively changes the operation mode in response to the modified mode selection parameter.

14. The computer system according to claim 13, wherein when the modified mode selection parameter represents that the computer system is to switch from the first operation mode to the second operation mode, the mode selection device reproduces contents of the auxiliary storage device to the main storage device and stores the modified mode selection parameter, and the enable control unit disables the auxiliary storage device.

15. The computer system according to claim 15, wherein when the modified mode selection parameter represents that the computer system is to switch from the second operation mode to the first operation mode, the mode selection device stores the modified mode selection parameter and keeps the computer system operating in the second operation mode.

16. The computer system according to claim 10, wherein the mode selection device initializes the main storage device and the auxiliary storage device when the computer system is activated.

17. The computer system according to claim 10, wherein the main storage device is a hard disk drive and the auxiliary storage device is a solid state drive.

18. The computer system according to claim 10, wherein the mode selection parameter is modified via an operation interface or is modified according to a power utilization status of the computer system.

19. The computer system according to claim 10, wherein the mode selection parameter represents the first operation mode when the computer system is powered by an external power source; and the mode selection parameter represents the second operation mode when the computer system is powered by a battery device.
